(19) United States
(12) Patent Application Publication
(10) Pub. No.: US 2026/0333002 A1
(43) Pub. Date: Oct. 22, 2026

(54) TRANSMITTING PERSONAL SAFETY MESSAGES INVOLVING VULNERABLE ROAD USERS

(71) Applicant: QUALCOMM Incorporated, San Diego, CA (US)

(72) Inventors: Hui GUO, Beijing (CN); Anantharaman BALASUBRAMANIAN, San Diego, CA (US); Dan VASSILOVSKI, Del Mar, CA (US); Gene Wesley MARSH, San Diego, CA (US); Lan YU, Beijing (CN)

(21) Appl. No.: 19/110,587

(22) PCT Filed: Oct. 27, 2022
(86) PCT No.: PCT/CN2022/127853

§ 371 Date: Mar. 11, 2025

(51) Int. Cl. H04W 4/40; G08G 1/16; H04W 64/00

(52) U.S. Cl. CPC H04W 4/40; G08G 1/16; H04W 64/00

(57) ABSTRACT

Various aspects of the present disclosure generally relate to wireless communication. In some aspects, a user equipment (UE) may detect an event involving a vulnerable road user (VRU) associated with the UE. The UE may transmit, to one or more receiving nodes and based at least in part on the event being detected, a personal safety message (PSM) that indicates information associated with the UE. Numerous other aspects are described.

### FIELD OF THE DISCLOSURE

Aspects of the present disclosure generally relate to wireless communication and to techniques and apparatuses for transmitting personal safety messages (PSMs) involving vulnerable road users (VRUs).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: detect an event involving a vulnerable road user (VRU) associated with the UE; and transmit, to one or more receiving nodes and based at least in part on the event being detected, a personal safety message (PSM) that indicates information associated with the UE.

In some implementations, a method of wireless communication performed by an apparatus of a UE includes detecting an event involving a VRU associated with the UE; and transmitting, to one or more receiving nodes and based at least in part on the event being detected, a PSM that indicates information associated with the UE.

In some implementations, a non-transitory computer-readable medium storing a set of instructions for wireless communication includes one or more instructions that, when executed by one or more processors of a UE, cause the UE to: detect an event involving a VRU associated with the UE; and transmit, to one or more receiving nodes and based at least in part on the event being detected, a PSM that indicates information associated with the UE.

In some implementations, an apparatus for wireless communication includes means for detecting an event involving a VRU associated with the apparatus; and means for transmitting, to one or more receiving nodes and based at least in part on the event being detected, a PSM that indicates information associated with the apparatus.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a vulnerable road user (VRU) scenario, in accordance with the present disclosure.

FIG. 5 is a diagram illustrating an example of a VRU scenario, in accordance with the present disclosure.

FIG. 6 is a diagram illustrating an example associated with transmitting personal safety messages (PSMs) involving VRUs, in accordance with the present disclosure.

FIG. 7 is a diagram illustrating an example process associated with transmitting PSMs involving VRUs, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

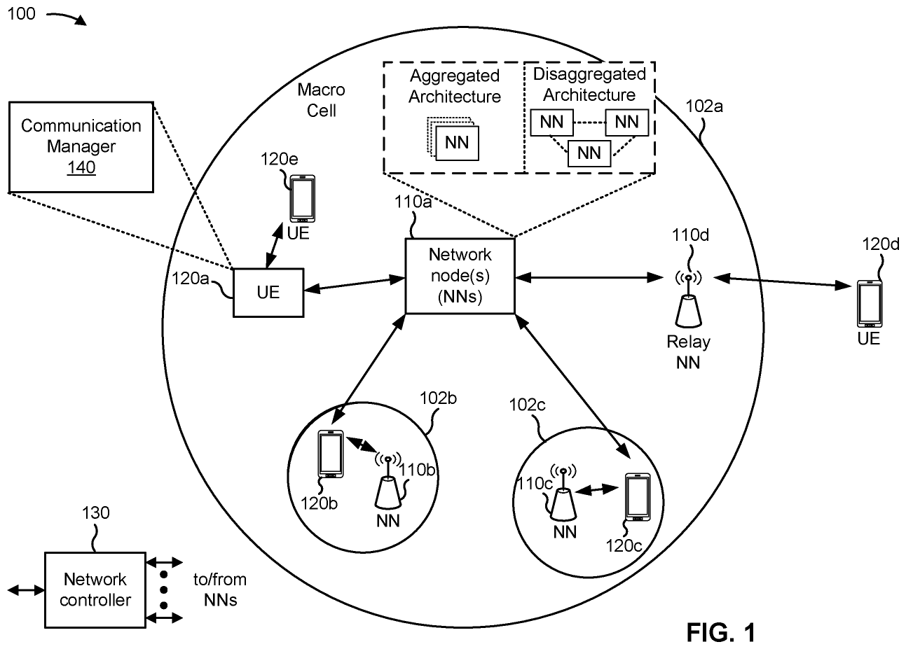

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may detect an event involving a vulnerable road user (VRU) associated with the UE; and transmit, to one or more receiving nodes and based at least in part on the event being detected, a personal safety message (PSM) that indicates information associated with the UE. Additionally, or alternatively, the communication manager 140 may perform one or more other operations described herein.

As indicated above, FIG. 1 is provided as an example. Other examples may differ from what is described with regard to FIG. 1.

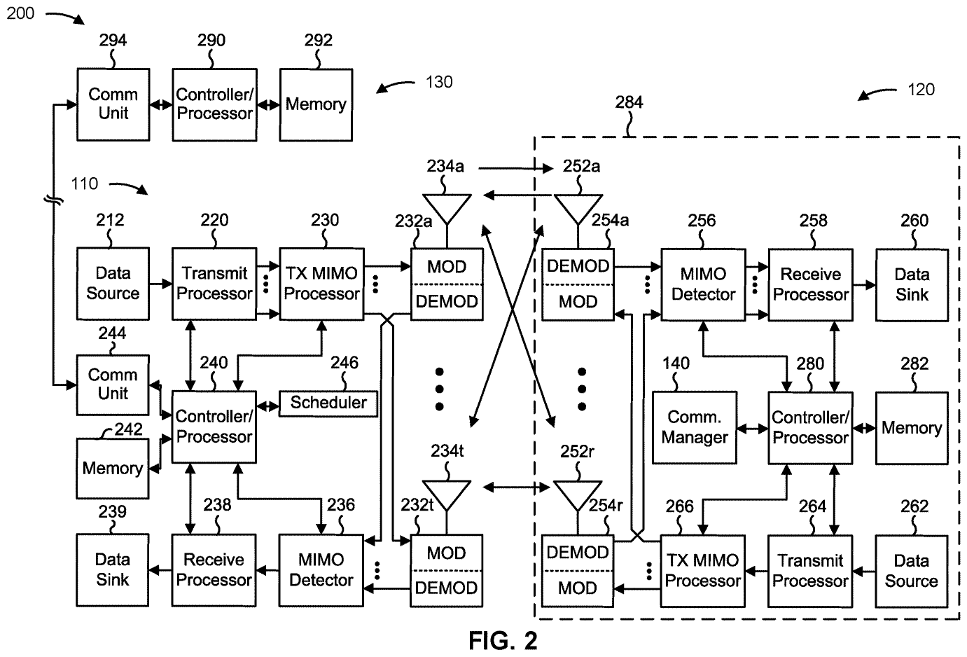

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

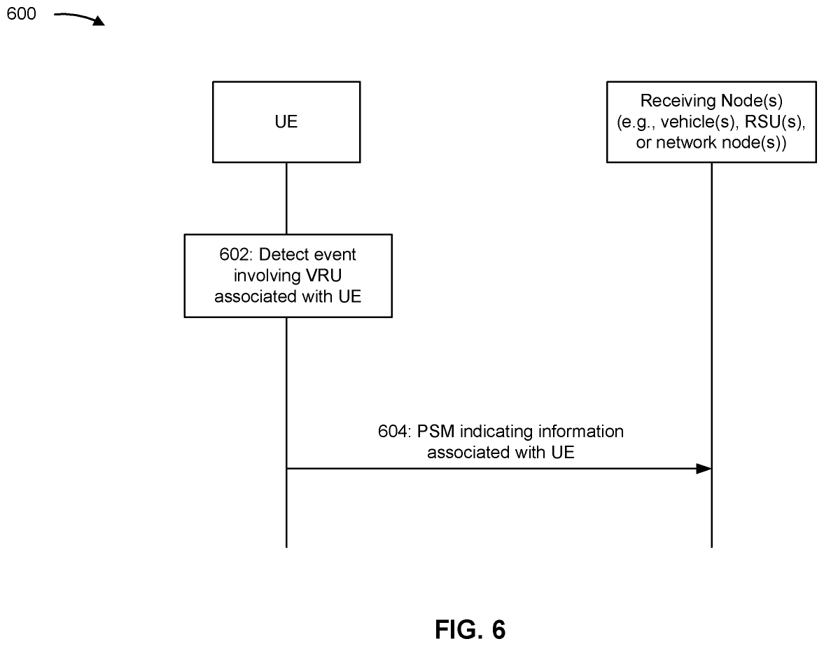

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-8).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-8).

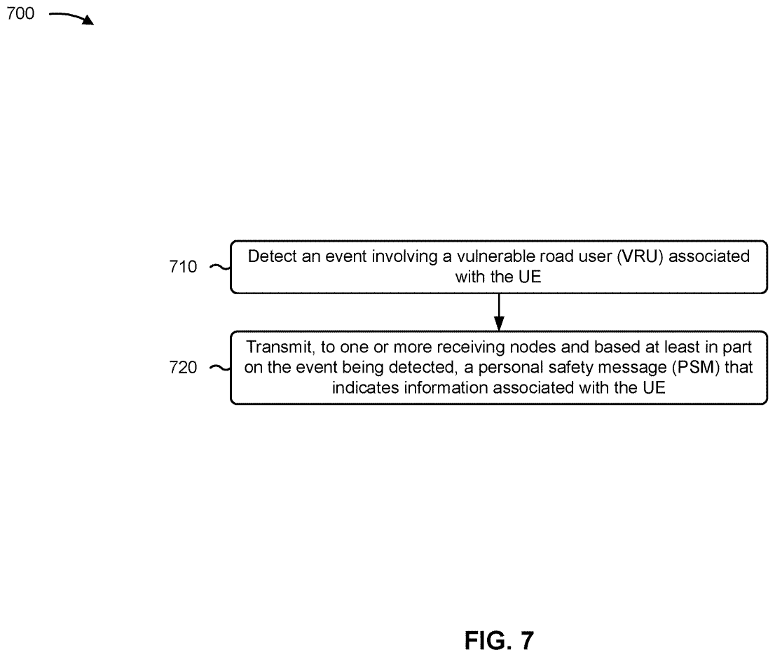

The controller/processor 240 of the network node 110, the controller/processor 280 of the UE 120, and/or any other component(s) of FIG. 2 may perform one or more techniques associated with transmitting PSMs involving VRUs, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, and/or other processes as described herein. In some examples, executing instructions may include running the instructions, converting the instructions, compiling the instructions, and/or interpreting the instructions, among other examples.

In some aspects, a UE (e.g., UE 120) includes means for detecting an event involving a VRU associated with the UE; and/or means for transmitting, to one or more receiving nodes and based at least in part on the event being detected, a PSM that indicates information associated with the UE. In some aspects, the means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit, among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

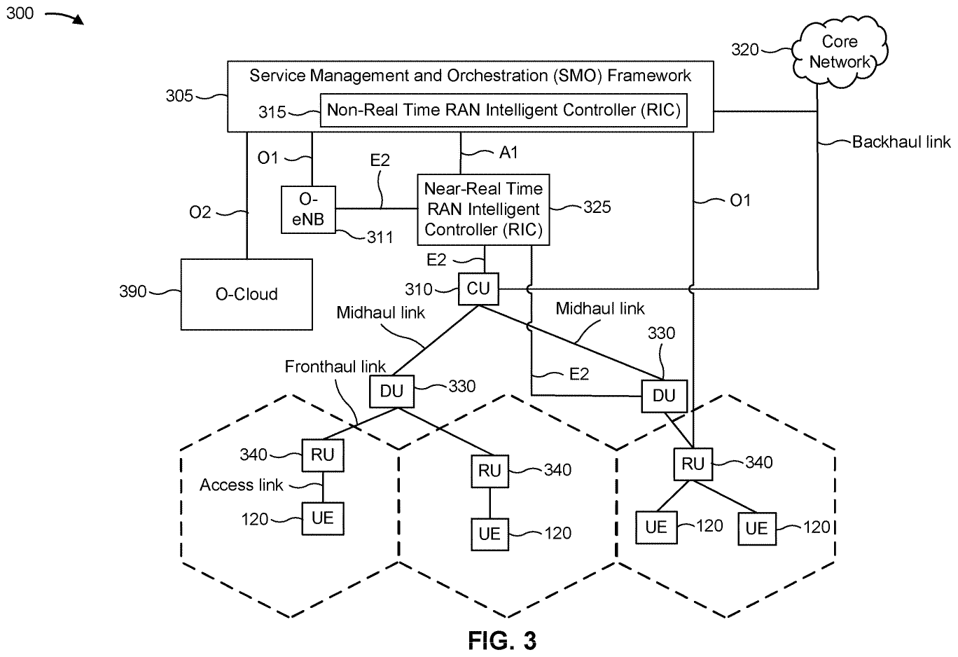

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

Road safety is an important aspect of mobility for both individuals and policymakers. VRUs may account for almost half of road accident victims. VRUs may include pedestrians, cyclists, motorcyclists, road workers, wheelchair users, and/or electric scooter users. VRUs may carry UEs, which may be PC5 enabled. The UEs may transmit safety messages, such as PSMs, and/or VRU awareness messages (VAMs). Vehicles on the road may also be PC5 enabled. The vehicles may also transmit safety messages, such as cooperative awareness messages (CAMs), decentralized environment notification messages (DENMs), and/or basic safety messages (BSMs). VRUs may transmit safety messages to vehicles on the road, and vice versa, via a sidelink interface.

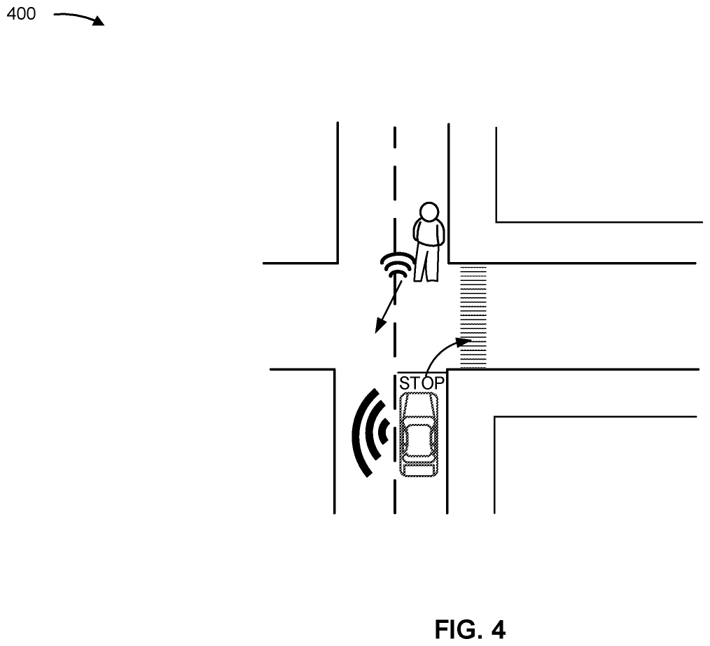

FIG. 4 is a diagram illustrating an example 400 of a VRU scenario, in accordance with the present disclosure.

As shown in FIG. 4, a user may be walking alongside a road, and the user may attempt to cross the road. The user may be a pedestrian, so the user may be classified as a VRU. A vehicle may be driving on the road. The vehicle may be stopped at a stop sign, and the vehicle may signal a right turn. However, if the vehicle instead moves straight (e.g., without making the right turn), the user may be in the path of the vehicle, thereby posing a safety threat to the user. In this VRU situation, a UE associated with the user may communicate a safety message to the vehicle, or vice versa, to avoid a collision between the user and the vehicle.

As indicated above, FIG. 4 is provided as an example. Other examples may differ from what is described with regard to FIG. 4.

A PSM may be associated with a VRU safety use case. The PSM may be associated with a pedestrian-to-everything (P2X) communication mode. The PSM may be triggered in a periodic manner. The PSM may be for safety. The PSM may indicate a message count, a temporary identifier, time information, position information (e.g., X, Y, and Z coordinates) associated with a transmitter (e.g., a transmitter that transmits the PSM), position accuracy information, speed information associated with the transmitter, heading information associated with the transmitter, acceleration information associated with the transmitter, and/or a path history associated with the transmitter.

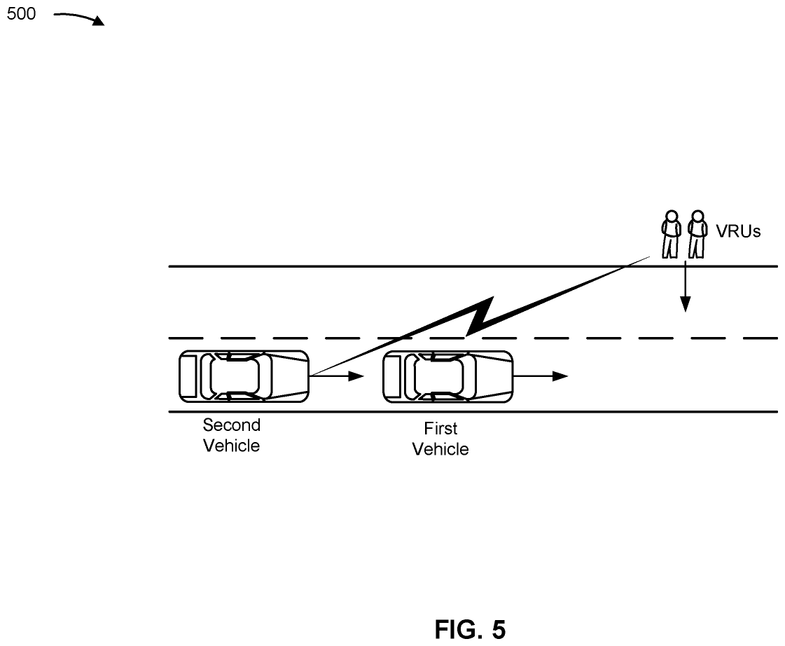

FIG. 5 is a diagram illustrating an example 500 of a VRU scenario, in accordance with the present disclosure.

As shown in FIG. 5, a first vehicle may be traveling on a road. A second vehicle may be traveling behind the first vehicle on the road. A VRU may be attempting to cross the road in front of the first vehicle. A UE associated with the VRU may transmit a message (e.g., a PSM) to the second vehicle. The second vehicle may forward the message to the first vehicle. The first vehicle may make a decision (e.g., slow down due to the VRU crossing the road) based on the message.

As indicated above, FIG. 5 is provided as an example. Other examples may differ from what is described with regard to FIG. 5.

According to a PSM design, a PSM indicating VRU information (e.g., position information, accuracy information, and/or heading information) may be periodically transmitted from a UE associated with a VRU. The UE may also be referred to as a VRU UE or a VRU device. The PSM may be detected and processed by nearby vehicles and/or roadside units (RSUs). The PSM may be detected and processed by a network node and/or by a cloud service. The PSM may be detected and processed so that other vehicles may take appropriate actions (e.g., stop, turn left, turn right, or slow down) when a collision is predicted based at least in part on the message. The transmission and reception of PSMs may consume UE power and increase a UE processing complexity. The UEs may transmit such PSMs in a periodic manner, even though the UEs may sometimes be in high-risk areas or low-risk areas, which may increase a UE power consumption and processing complexity.

In various aspects of techniques and apparatuses described herein, a UE may detect an event involving a VRU associated with the UE. The UE may detect the event based at least in part on the VRU entering a geographic region associated with a high-risk zone. The UE may detect the event based at least in part on the VRU entering the geographic region associated with the high-risk zone and during a certain period of time. The UE may transmit, to one or more receiving nodes and based at least in part on the event being detected, a PSM that indicates information associated with the UE. The one or more receiving nodes may include nodes associated with one or more vehicles (in some cases a receiving node may be a vehicle), one or more RSUs, and/or one or more network nodes. In some aspects, the UE may transmit PSMs in certain high-risk areas at certain times, which may save UE power. Further, an adaptive PSM frequency (e.g., an adaptive PSM periodicity) may be enabled to reduce a UE transmission power and to reduce a vehicle/RSU processing effort, as well as to reduce channel loading. As a result, UE power and processing complexity may be reduced.

FIG. 6 is a diagram illustrating an example 600 associated with transmitting PSMs involving VRUs, in accordance with the present disclosure. As shown in FIG. 6, example 600 includes communication between a UE (e.g., UE 120) and a receiving node (e.g., network node 110, a vehicle, or an RSU). In some aspects, the UE and the receiving node may be included in a wireless network, such as wireless network 100.

In some aspects, the UE may be a VRU UE or a VRU device. The UE may be associated with a VRU. For example, the UE may be carried by the VRU. The receiving node may be a node associated with a vehicle, an RSU, and/or a network node.

As shown by reference number 602, the UE may detect an event involving the VRU associated with the UE. The UE may detect the event based at least in part on the VRU entering a geographic region associated with a high-risk zone. The UE may determine a current location associated with the UE, and based on the current location, the UE may detect when the geographic region associated with the high-risk zone has been entered by the UE. The high-risk zone may be based at least in part on a dynamic configuration or a static configuration. The high-risk zone may be configured based at least in part on real-time traffic information. The high-risk zone may be based at least in part on a broadcast from the network node. The UE may detect the event based at least in part on the VRU entering the geographic region associated with the high-risk zone and during a certain period of time. In other words, the UE may detect the event based at least in part on the high-risk zone and the certain period of time (or time of day).

As shown by reference number 604, the UE may transmit, to one or more receiving nodes and based at least in part on the event being detected, a PSM that indicates information associated with the UE. The one or more receiving nodes may be in proximity to the UE. For example, multiple vehicles that are located within a certain distance from the UE (e.g., within 100 meters) may be able to receive the PSM. As another example, an RSU that is within the certain distance from the UE may be able to receive the PSM. In some cases, the UE may transmit the PSM to one or more network nodes. The PSM may indicate the information associated with the UE, which may include a message count, a temporary identifier, time information, position information (e.g., X, Y, and Z coordinates) associated with the UE, position accuracy information, speed information associated with the UE, heading information associated with the UE, acceleration information associated with the UE, and/or a path history associated with the UE.

In some aspects, a transmission of the PSM from the UE may be triggered from an application layer to save UE power. The transmission of the PSM may be triggered by an occurrence of the event. The UE may transmit the PSM based at least in part on the VRU entering the high-risk zone. The event may occur when the VRU enters the high-risk zone. The UE may transmit the PSM based at least in part on the VRU entering the high-risk zone at the certain time during the day. The event may occur when the UE enters the high-risk zone at the certain time during the day. For example, an intersection area during 8 AM to 8 PM may be marked as a high-risk zone. The UE may trigger periodic PSM transmissions when the UE is located in the high-risk zone at a given time duration. An identification of a high-risk zone may be static or dynamic, and may be configured in the application layer based at least in part on a geography and up-to-date traffic data. For example, a school zone during 7 AM to 9 AM and from 4 PM to 6 PM in semester months may be marked as a high-risk zone. In one case, a new construction zone may be identified as a high-risk zone during a certain period. The network node may broadcast zone information, and the zone information may be updated by an infrastructure or by a cloud environment. The zone information may indicate specific geographic areas that are associated with high-risk zones.

In some aspects, the UE may determine position information associated with the UE. The position information may include geographic coordinates associated with the UE. The UE may determine a positioning accuracy (or UE positioning accuracy) associated with the positioning information. The UE may determine a confidence level associated with the positioning information, where the confidence level may be indicative of the positioning accuracy. The UE may determine to stop transmitting PSMs based at least in part on the positioning accuracy satisfying a threshold. For example, when the positioning accuracy is below the threshold, the UE may determine to stop transmitting PSMs. As a result, the transmission (or forwarding) of PSMs may depend on the positioning accuracy.

In some aspects, the transmission of the PSM may be dependent on a UE capability and/or a power saving demand. A low positioning accuracy may cause a PSM reception to be ineffective for vehicles to detect and act accordingly. A vehicle may drop a PSM packet when a reported positioning accuracy is lower than a threshold. The UE may not transmit the PSM when the positioning accuracy does not satisfy the threshold. A high UE power saving demand may lead to a relatively long PSM periodicity (e.g., less frequent PSM transmissions may save UE power).

In some aspects, the PSM transmitted by the UE may be detected by the RSU. The PSM may indicate information (e.g., position information) related to the user and/or the UE. The RSU may also transmit the information via a roadside information (RSI) message, which may be based at least in part on the PSM detection or a roadside sensor(s) perception. The RSU may transmit the information depending on the positioning accuracy and/or the confidence level. For example, when the positioning accuracy and/or the confidence level does not satisfy a certain threshold, the RSU may not transmit the information. When one VRU does not perfectly appear in a roadside sensor's field of view, the sharing of information may not be helpful to other vehicles but instead may be wasteful from the vehicle perspective. Thus, the RSU may not always transmit the information.

In some aspects, the UE may transmit the PSM to the network node via a Uu interface between the UE and the network node. The PSM may indicate information (e.g., position information) related to the user and/or the UE. The network node may transmit the information (e.g., to vehicles) depending on the positioning accuracy and/or the confidence level. The network node may not forward information with poor positioning accuracy when, for example, a channel loading is relatively high.

In some aspects, the PSM may be a periodic PSM, a semi-persistent PSM, and/or an event-triggered PSM. The PSM may be transmitted periodically, semi-persistently, or a single time after being triggered. In some aspects, the UE may transmit the PSM via a PC5 interface (e.g., a sidelink interface). The UE may reserve a resource to transmit the PSM. Vehicles and RSUs in proximity to the UE may be expected receivers.

In some aspects, transmission resources for the PSM and transmission resources for other messages may be in the same resource pool, where the other messages may include basic system messages (BSMs). A priority for each message type may be defined in the application layer. A priority associated with a BSM may be higher than a priority associated with the PSM. For example, the priority of the BSM may always be higher than the priority of the PSM, such that a preemption and resource reselection may be enabled. A priority associated with a PSM in a high-risk area may be higher than a priority associated with a PSM in a medium-risk area and a priority associated with the BSM. A differentiation of PSM priority in a certain area at a certain time may be useful for packet dropping and/or packet prioritization. Thus, for effective resource usage, the priority of the PSM and the other messages may be indicated in the application layer to enable the resource preemption and reselection.

In some aspects, in certain regions, an RSU and a vehicle may use an independent resource pool. The RSU may forward the PSM using resource pool #0, or the UE may transmit the PSM in resource pool #1. In such cases, whether or not the same resource pool is used may depend on an originator of the PSM. Further, the priority for each message type may be determined in a regional standard.

In some aspects, the UE may receive, from the network node, a configuration that indicates a PSM periodicity and/or a maximum number of permitted PSM retransmissions. The PSM periodicity may be based at least in part on a reported channel busy ratio (CBR) level. The maximum number of permitted PSM retransmissions may be based at least in part on the PSM periodicity. In order to reduce a UE complexity and a vehicle complexity, and a power and channel loading, an adaptive PSM periodicity and the maximum number of permitted PSM retransmissions may be configured based at least in part on the CBR, the positioning accuracy, and the power saving demand.

In some aspects, the adaptive PSM periodicity may be determined in order to provide a congestion control of PSM transmissions (or PSM congestion control). The CBR may be defined, and the PSM periodicity may be based at least in part on the CBR. For example, a mapping table between CBR and PSM periodicity may define a first index. The first index (0) may correspond to a CBR range of [0, α] and a PSM periodicity (P_{PSM}) (in ms) of 100. A second index (1) may correspond to a CBR range of [a, b] and a P_{PSM} of 200. A third second index (2) may correspond to a CBR range of [b, c] and a P_{PSM} of 600. A fourth index (3) may correspond to a CBR range of [c, 1] and a PPSM of 1000. A longer periodicity of PSM may be used for a higher CBR (e.g., when the channel is busy, PSM transmissions may be less frequent, to reduce the consumption of channel resources). A mapping configuration and appropriate thresholds may be configured by the network node. In one case, P_{PSM} may be indicated by the network node to the UE directly based at least in part on a UE reported CBR level. In some aspects, for a higher PSM periodicity (e.g., 1000 ms), limited maximum transmission times may be configured because a retransmission of outdated information may not be necessary. For example, when P_{PSM}=100 ms, N_{max,Tx}=4, and when P_{PSM}=1000 ms, N_{max,Tx}=1. In other words, the UE may retransmit the same information up to four times when the PSM periodicity is 100 ms, but the UE may only retransmit the information one time when the PSM periodicity is 1000 ms (e.g., the information may likely be outdated if transmitted again 1000 ms later). The maximum transmission times may be configured in order to reduce intra-band interference as well as channel loading.

In some aspects, the UE may receive, from one or more other UEs in proximity to the UE, information regarding one or more VRUs associated with the one or more other UEs. The UE may transmit, to the one or more receiving nodes, consolidated information that consolidates the information regarding the one or more VRUs associated with the one or more other UEs.

In some aspects, VRUs, such as pedestrians, cyclists, or motorcyclists, etc., may often appear geographically close to each other. For example, several pedestrians may walk in the same direction together on the sidewalk at a similar pace. In such cases, differentiating each user may become difficult and not necessary from a PSM receiver point of view. In some aspects, the UE that transmits the PSM may consolidate information of multiple users in proximity, which may save UE power and reduce a receiver detection effort. Position information of nearby users may be consolidated to save UE transmission power and reduce a receiver complexity. In one example, for an RSU to forward a PSM or transmit the PSM based at least in part on roadside sensors, the RSU may consolidate information into one message when multiple VRUs are within a defined distance from each other (e.g., within a certain range of each other). In another example, UEs may exchange information with nearby UEs, such that one UE may transmit a PSM on behalf of another UE (and the VRU associated with that UE), especially when the other UE is associated with a high power-saving demand.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with transmitting PSMs involving VRUs.

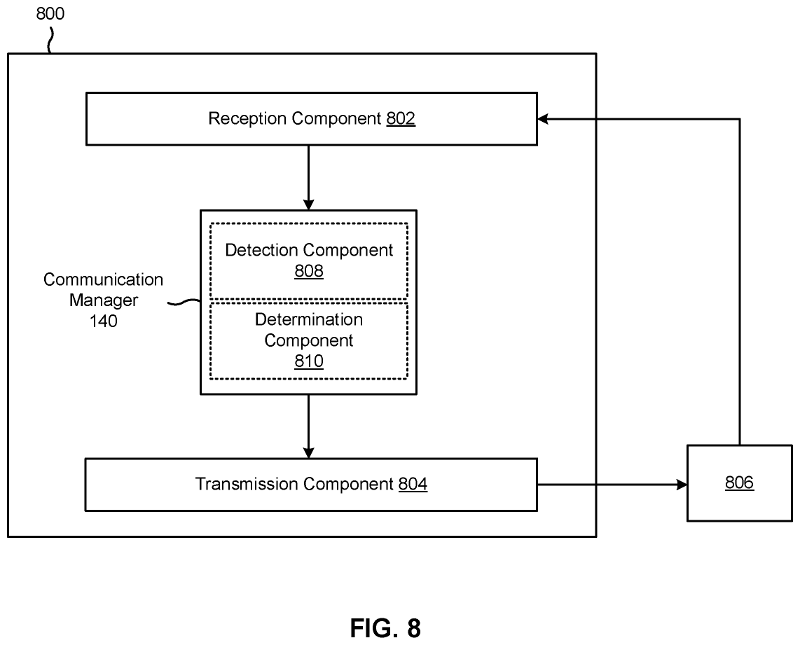

As shown in FIG. 7, in some aspects, process 700 may include detecting an event involving a VRU associated with the UE (block 710). For example, the UE (e.g., using communication manager 140 and/or detection component 808, depicted in FIG. 8) may detect an event involving a VRU associated with the UE, as described above.

As further shown in FIG. 7, in some aspects, process 700 may include transmitting, to one or more receiving nodes and based at least in part on the event being detected, a PSM that indicates information associated with the UE (block 720). For example, the UE (e.g., using communication manager 140 and/or transmission component 804, depicted in FIG. 8) may transmit, to one or more receiving nodes and based at least in part on the event being detected, a PSM that indicates information associated with the UE, as described above.

Process 700 may include additional aspects, such as any single aspect or any combination of aspects described below and/or in connection with one or more other processes described elsewhere herein.

In a first aspect, the event is detected based at least in part on the VRU entering a geographic region associated with a high-risk zone.

In a second aspect, alone or in combination with the first aspect, the high-risk zone is based at least in part on a dynamic configuration or a static configuration.

In a third aspect, alone or in combination with one or more of the first and second aspects, the high-risk zone is configured based at least in part on real-time traffic information.

In a fourth aspect, alone or in combination with one or more of the first through third aspects, the high-risk zone is based at least in part on a broadcast from a network node.

In a fifth aspect, alone or in combination with one or more of the first through fourth aspects, the event is detected based at least in part on the VRU entering a geographic region associated with a high-risk zone and during a certain period of time.

In a sixth aspect, alone or in combination with one or more of the first through fifth aspects, the one or more receiving nodes include one or more of a vehicle, an RSU, or a network node.

In a seventh aspect, alone or in combination with one or more of the first through sixth aspects, process 700 includes determining position information associated with the UE, determining a positioning accuracy associated with the positioning information, and determining to stop transmitting PSMs based at least in part on the positioning accuracy satisfying a threshold.

In an eighth aspect, alone or in combination with one or more of the first through seventh aspects, the PSM is a periodic PSM, a semi-static PSM, or a trigger-based PSM.

In a ninth aspect, alone or in combination with one or more of the first through eighth aspects, transmission resources for the PSM and transmission resources for other messages are from a same resource pool as other messages, and the other messages include a BSM.

In a tenth aspect, alone or in combination with one or more of the first through ninth aspects, a priority associated with the BSM is higher than a priority associated with the PSM.

In an eleventh aspect, alone or in combination with one or more of the first through tenth aspects, a priority associated with a PSM in a high-risk area is higher than a priority associated with a PSM in a medium-risk area and a priority associated with the BSM.

In a twelfth aspect, alone or in combination with one or more of the first through eleventh aspects, process 700 includes receiving, from a network node, a configuration that indicates one or more of a PSM periodicity and a maximum number of permitted PSM retransmissions, wherein the PSM periodicity is based at least in part on a reported CBR level, and the maximum number of permitted PSM retransmissions is based at least in part on the PSM periodicity.

In a thirteenth aspect, alone or in combination with one or more of the first through twelfth aspects, process 700 includes receiving, from one or more other UEs in proximity to the UE, information regarding one or more VRUs associated with the one or more other UEs, and transmitting, to the one or more receiving nodes, consolidated information that consolidates the information regarding the one or more VRUs associated with the one or more other UEs.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a detection component 808, or a determination component 810, among other examples.

In some aspects, the apparatus 800 may be configured to perform one or more operations described herein in connection with FIG. 6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The detection component 808 may detect an event involving a VRU associated with the UE. The transmission component 804 may transmit, to one or more receiving nodes and based at least in part on the event being detected, a PSM that indicates information associated with the UE.

The determination component 810 may determine position information associated with the UE. The determination component 810 may determine a positioning accuracy associated with the positioning information. The determination component 810 may determine to stop transmitting PSMs based at least in part on the positioning accuracy satisfying a threshold.

The reception component 802 may receive, from a network node, a configuration that indicates one or more of a PSM periodicity and a maximum number of permitted PSM retransmissions, wherein the PSM periodicity is based at least in part on a reported channel busy ratio level, and wherein the maximum number of permitted PSM retransmissions is based at least in part on the PSM periodicity.

The reception component 802 may receive, from one or more other UEs in proximity to the UE, information regarding one or more VRUs associated with the one or more other UEs. The transmission component 804 may transmit, to the one or more receiving nodes, consolidated information that consolidates the information regarding the one or more VRUs associated with the one or more other UEs.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by an apparatus of a user equipment (UE), comprising: detecting an event involving a vulnerable road user (VRU) associated with the UE; and transmitting, to one or more receiving nodes and based at least in part on the event being detected, a personal safety message (PSM) that indicates information associated with the UE.

Aspect 2: The method of Aspect 15, wherein the event is detected based at least in part on the VRU entering a geographic region associated with a high-risk zone.

Aspect 3: The method of Aspect 16, wherein the high-risk zone is based at least in part on a dynamic configuration or a static configuration.

Aspect 4: The method of Aspect 16, wherein the high-risk zone is configured based at least in part on real-time traffic information.

Aspect 5: The method of Aspect 16, wherein the high-risk zone is based at least in part on a broadcast from a network node.

Aspect 6: The method of Aspect 15, wherein the event is detected based at least in part on the VRU entering a geographic region associated with a high-risk zone and during a certain period of time.

Aspect 7: The method of Aspect 15, wherein the one or more receiving nodes include one or more of: a node associated with a vehicle, a roadside unit, or a network node.

Aspect 8: The method of Aspect 15, further comprising: determining position information associated with the UE; determining a positioning accuracy associated with the positioning information; and determining to stop transmitting PSMs based at least in part on the positioning accuracy satisfying a threshold.

Aspect 9: The method of Aspect 15, wherein the PSM is a periodic PSM, a semi-static PSM, or a trigger-based PSM.

Aspect 10: The method of Aspect 15, wherein transmission resources for the PSM and transmission resources for other messages are from a same resource pool as other messages, and the other messages include a basic system message (BSM).

Aspect 11: The method of Aspect 24, wherein a priority associated with the BSM is higher than a priority associated with the PSM.

Aspect 12: The method of Aspect 24, wherein a priority associated with a PSM in a high-risk area is higher than a priority associated with a PSM in a medium-risk area and a priority associated with the BSM.

Aspect 13: The method of Aspect 15, further comprising: receiving, from a network node, a configuration that indicates one or more of a PSM periodicity and a maximum number of permitted PSM retransmissions, wherein the PSM periodicity is based at least in part on a reported channel busy ratio level, and wherein the maximum number of permitted PSM retransmissions is based at least in part on the PSM periodicity.

Aspect 14: The method of Aspect 15, further comprising: receiving, from one or more other UEs in proximity to the UE, information regarding one or more VRUs associated with the one or more other UEs; and transmitting, to the one or more receiving nodes, consolidated information that consolidates the information regarding the one or more VRUs associated with the one or more other UEs.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
a memory; and
one or more processors, coupled to the memory, configured to:
detect an event involving a vulnerable road user (VRU) associated with the UE; and
transmit, to one or more receiving nodes and based at least in part on the event being detected, a personal safety message (PSM) that indicates information associated with the UE.

2. The apparatus of claim 1, wherein the event is detected based at least in part on the VRU entering a geographic region associated with a high-risk zone.

3. The apparatus of claim 2, wherein the high-risk zone is based at least in part on a dynamic configuration or a static configuration.

4. The apparatus of claim 2, wherein the high-risk zone is configured based at least in part on real-time traffic information.

5. The apparatus of claim 2, wherein the high-risk zone is based at least in part on a broadcast from a network node.

6. The apparatus of claim 1, wherein the event is detected based at least in part on the VRU entering a geographic region associated with a high-risk zone and during a certain period of time.

7. The apparatus of claim 1, wherein the one or more receiving nodes include one or more of: a node associated with a vehicle, a roadside unit, or a network node.

8. The apparatus of claim 1, wherein the one or more processors are further configured to:
determine position information associated with the UE;
determine a positioning accuracy associated with the positioning information; and
determine to stop transmitting PSMs based at least in part on the positioning accuracy satisfying a threshold.

9. The apparatus of claim 1, wherein the PSM is a periodic PSM, a semi-static PSM, or a trigger-based PSM.

10. The apparatus of claim 1, wherein transmission resources for the PSM and transmission resources for other messages are from a same resource pool as other messages, and the other messages include a basic system message (BSM).

11. The apparatus of claim 10, wherein a priority associated with the BSM is higher than a priority associated with the PSM.

12. The apparatus of claim 10, wherein a priority associated with a PSM in a high-risk area is higher than a priority associated with a PSM in a medium-risk area and a priority associated with the BSM.

13. The apparatus of claim 1, wherein the one or more processors are further configured to:
receive, from a network node, a configuration that indicates one or more of a PSM periodicity and a maximum number of permitted PSM retransmissions, wherein the PSM periodicity is based at least in part on a reported channel busy ratio level, and wherein the maximum number of permitted PSM retransmissions is based at least in part on the PSM periodicity.

14. The apparatus of claim 1, wherein the one or more processors are further configured to:
receive, from one or more other UEs in proximity to the UE, information regarding one or more VRUs associated with the one or more other UEs; and
transmit, to the one or more receiving nodes, consolidated information that consolidates the information regarding the one or more VRUs associated with the one or more other UEs.

15. A method of wireless communication performed by an apparatus of a user equipment (UE), comprising:
detecting an event involving a vulnerable road user (VRU) associated with the UE; and
transmitting, to one or more receiving nodes and based at least in part on the event being detected, a personal safety message (PSM) that indicates information associated with the UE.

16. The method of claim 15, wherein the event is detected based at least in part on the VRU entering a geographic region associated with a high-risk zone.

17. The method of claim 16, wherein the high-risk zone is based at least in part on a dynamic configuration or a static configuration.

18. The method of claim 16, wherein the high-risk zone is configured based at least in part on real-time traffic information.

19. The method of claim 16, wherein the high-risk zone is based at least in part on a broadcast from a network node.

20. The method of claim 15, wherein the event is detected based at least in part on the VRU entering a geographic region associated with a high-risk zone and during a certain period of time.

21-30. (canceled)
